(19) United States
(12) Patent Application Publication
(10) Pub. No.: US 2009/0151007 A1
(43) Pub. Date: Jun. 11, 2009

(54) DIGITAL RIGHTS MANAGEMENT FOR RETRIEVING MEDICAL DATA FROM A SERVER

(75) Inventors: Robert Paul Koster, Eindhoven (NL); Willem Jonker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/282,896

(22) PCT Filed: Mar. 7, 2007
(86) PCT No.: PCT/IB07/50750

§ 371 Date: Sep. 15, 2008

(30) Foreign Application Priority Data
Mar. 15, 2006 (EP) 06111197.7

(51) Int. Cl. G06F 21/00

(52) U.S. Cl. 726/30

(57) ABSTRACT

The invention relates to a method of and system for retrieving medical data from a server, the method comprising: requesting the medical data from the server by an uncertified client; installing a certified digital rights management service on the uncertified client; managing the requested medical data according to the installed certified digital rights management service thereby retrieving the medical data from the server; the system comprising means for requesting the medical data from the server by an uncertified client means for installing a certified digital rights management service on the uncertified client; means for managing the requested medical data according to the installed certified digital rights management service thereby retrieving the medical data from the server.

The invention relates to a method of retrieving medical data from a server.

The invention further relates to a system for retrieving medical data from a server.

The invention further relates to a server for use in such a system.

The invention further relates to a client for use in such a system.

The invention further relates to a medical workstation comprising such a client.

The invention further relates to a medical information management system comprising such a system.

The invention further relates to a digital rights management service for use in such a method or system.

Nowadays, a lot of medical data such as medical images and patient data, such as name, gender, allergies etc. are stored digitally in a database on a dedicated server. An example that relates to medical images is a Picture Archiving and Communications System (PACS) that organizes amongst others a central storage of the images in a database on a dedicated server. The medical images are sent from an image acquisition system to the server and the medical images can be viewed for reviewing by retrieving them from the server and showing them on a workstation. Such architecture is generally referred to as client-server architecture.

Another example of such a medical information management system is a Hospital Information System (HIS) that organizes administrative patient data, such as billing, the laboratory exams etc. or a Radiology Information System (RIS) that organizes for example the scheduling of the patients on the acquisition stations.

The medical data is subject to rules of privacy and security because of the inherent personal nature of the data, which is usually regulated by the national government, e.g. the Health Insurance Portability and Accountability Act (HIPAA) in the United States. Such rules of security may include for example that only certain persons may have access to the patient data and that the patient data may not be changed.

The security rules are implemented, i.e. enforced, at different places where the data may reside, for example when the data is stored in the database, when it is viewed at the workstation or when it is transferred to and from the server over a network, such as a Local Area Network (LAN) or Wide Access Network (WAN) using the Internet. Usually, within the boundaries of a hospital a private network, such as Intranet, is used to secure that there's no unauthorized access to the network, and thereby the data, from outside the boundaries of the hospital.

With the introduction of wireless networks, the network becomes more and more open to the public. Further hospitals and physicians have a desire to exchange the medical data from a patient over the Internet, so there's the need for access to private medical data over the public Internet. A typical example are emergency cases where ambulance or first aid personnel needs access to data while being outside the physical premises, outside the private network or even outside the organizational structure that manages the required data.

An example of a method of retrieving medical data from a server is disclosed in U.S. Pat. No. 6,876,985 that enables a hospital or other organization to store patient data in a public place while maintaining the confidentiality thereof. The disclosed patient information management method comprises a storage management device wherein patient information is encrypted so that it can be decrypted when both patient Identification (ID) information and a password decided by a patient are used. The encrypted patient information is stored in a storage device. The storage management device issues a use request to the storage device to receive encrypted patient information, and used patient ID information and a password to decrypt it for use.

Such protection of the digital data, here digital medical data, is generally referred to as Digital Rights Management (DRM). With DRM one can for example protect the number of copies that are allowed of the digital data, control the users that have access to the digital data, control how users use data and control changes to the digital data. These policies are managed and described using licenses. These licenses contain a rights expression expressing the policy and accompany the encrypted content. After evaluation of the rights expression the related encryption key is used to decrypt the data. Hereto, the DRM must be implemented on the client to protect the copied content of the server, to securely evaluate the rights expression, to decrypt the content and to deliver the content to a trusted rendering application. A client that implements the DRM is certified to use the content of the server according to the rules enforced by the DRM. A client that does not implement the DRM is uncertified for such use. A trusted rendering application is an application that uses the content and is either part of the DRM or is known to the DRM. DRM control affects also the use of the content on the client in addition to traditional access control systems that for example require user authentication and verification but then give out the data without subsequent protection. The use of DRM on the client makes the client certified for the specific server, which therefore agrees to release data to such client. For an example of a DRM system, see S. Guth, A Sample DRM System, Digital Rights Management: Technological, Economic, Legal and Political Aspects, LNCS2770, Springer-Verlag, 2003. or see Open Mobile Alliance, DRM Architecture: Draft Version 2.0, 20-8-2004.

As a consequence the different devices, i.e. clients, that are used in or outside the hospital and that require access to the medical data stored on the server must implement the DRM of the server. However, different medical data servers may require different DRM being implemented on the client limiting the usability of the client. For example a portable heart monitor device that requests patient data such as age from a server may not be able to retrieve that information because it does not implement the required DRM. This problem is especially relevant in cases of a combination of third party care providers using different systems in emergency cases where time and accessibility to information is critical.

It is an object of the invention to provide a method of retrieving medical data from a server that improves the usability of a client. To achieve this object, the invention provides a method of retrieving medical data from a server according to the opening paragraph, the method comprising: requesting the medical data from the server by an uncertified client; installing a certified digital rights management service on the uncertified client; managing the requested medical data according to the installed certified digital rights management service thereby retrieving the medical data from the server. By installing a certified digital rights management service on an uncertified client when this client requests medical data from the server, the uncertified client does not need to know what kind of digital rights management is required by the server. Consequently, the client can be used for multiple servers each of the servers having its own digital rights management for the medical data. Thus the server provides a mechanism to enable the security and integrity of the medical data that is stored on the server according to the digital right management rules of the specific server. A further advantage of the DRM service is that trust and control stays in control of the server, since that party creates the DRM service and for example can control the robustness by obfuscation and other well-known techniques.

In an embodiment of the method according to the invention access to the medical data is restricted according to an access policy and the uncertified client is restricted to access the medical data according to a further access policy and the certified digital rights management service obtains a resulting policy based upon the access policy and the further access policy. Hereby, the privacy and security of the data is further controlled in a flexible way. Depending on the security, trust and robustness of both the client and DRM service the further access policy and thereby the resulting policy can be defined. This gives the advantage that the data can be used for the intended use, but not further, which increases privacy and security. A further advantage is that the further policy is added to the normal access policy for the data, and together accompany the data when delivered to the client, which has the advantage that up to the moment of use at the client device the policies are enforced. In an embodiment of the method according to the invention, the step of managing comprises limiting a usability period of the medical data by the uncertified client. Hereby, it is prevented that the medical data may be used on the client for an unlimited period.

In a further embodiment of the method according to the invention, the step of managing comprises limiting the retrieved amount of the requested medical data. Hereby, it is prevented that one client retrieves more medical data than allowed by the server. Furthermore, the privacy and security of the data is further controlled in a flexible way. Depending on the security, trust and robustness of the client, the DRM service, and the requesting authenticated user more or less data can be released. A further advantage is that this allows more contextual information to be taken into account for the decision to release data to a client. For example the system could deliver more data when a client or user is trusted, for example because it is recommended by an already trusted client or it has made correct requests in the past or the user is known.

In a further embodiment of the method according to the invention, the method further comprises logging the medical data request. Hereby, the requested medical data can be traced which may include tracing the client, the number of times data is requested, what data is requested, the time the medical data is requested etc.

In a further embodiment of the method according to the invention, the method further comprises authentication of a user before installing the certified digital rights management service or before delivering the data as part of the request. By requesting authentication, like for example by means of credit card verification, phone number, user identification, it can be controlled that a user operating the client is allowed to request the medical data. Furthermore, authentication, even when using weak forms, can increase the trust level, especially when used in determining the policy for the use and/or in determining the amount of data to be delivered. Some examples of weak forms of authentication are credit card numbers and email addresses. Using weak forms of authentication has a further advantage that no global trusted identity infrastructure is required, but that identity infrastructures of others can be used.

It is a further object of the invention to provide a system of retrieving medical data from a server that improves the usability of a client. To achieve this object, the invention provides a system of retrieving medical data from a server according to the opening paragraph, the system comprising: means for requesting the medical data from the server by an uncertified client; means for installing a certified digital rights management service on the uncertified client; means for managing the requested medical data according to the installed certified digital rights management service thereby retrieving the medical data from the server.

It is a further object of the invention to provide a server for use in a system of retrieving medical data from the server that improves the usability of a client. To achieve this object, the invention provides a server for use in a system according to the invention, the server comprising means for installing a certified digital rights management service on an uncertified client.

It is a further object of the invention to provide a client for use in a system of retrieving medical data from a server that improves the usability of the client. To achieve this object, the invention provides an uncertified client for use in a system according to the invention, the uncertified client comprising means for requesting the medical data from the server by the uncertified client.

It is a further object of the invention to provide a medical workstation of retrieving medical data from a server in that improves the usability of the medical workstation. To achieve this object, the invention provides a medical workstation comprising the uncertified client according to the invention. It is a further object of the invention to provide a medical information management system of retrieving medical data from a server that improves the usability of a client. To achieve this object, the invention provides a medical information management system comprising the system according to the invention.

The invention further provides a digital rights management service for use in a method or system according to the invention, the digital rights management service designed to be loaded by a computer arrangement comprising a processing unit and a memory, the digital rights management service, after being loaded, providing the processing unit with the capability to manage requests and responses from an uncertified client into request and responses for a server.

The same advantages are achieved for the system, the server, the client, the medical workstation, the medical information management system and the digital rights management service as described with reference to the method according to the invention.

These and other aspects of the invention will be apparent from and elucidated with reference to the embodiments described hereinafter as illustrated by the following Figures:

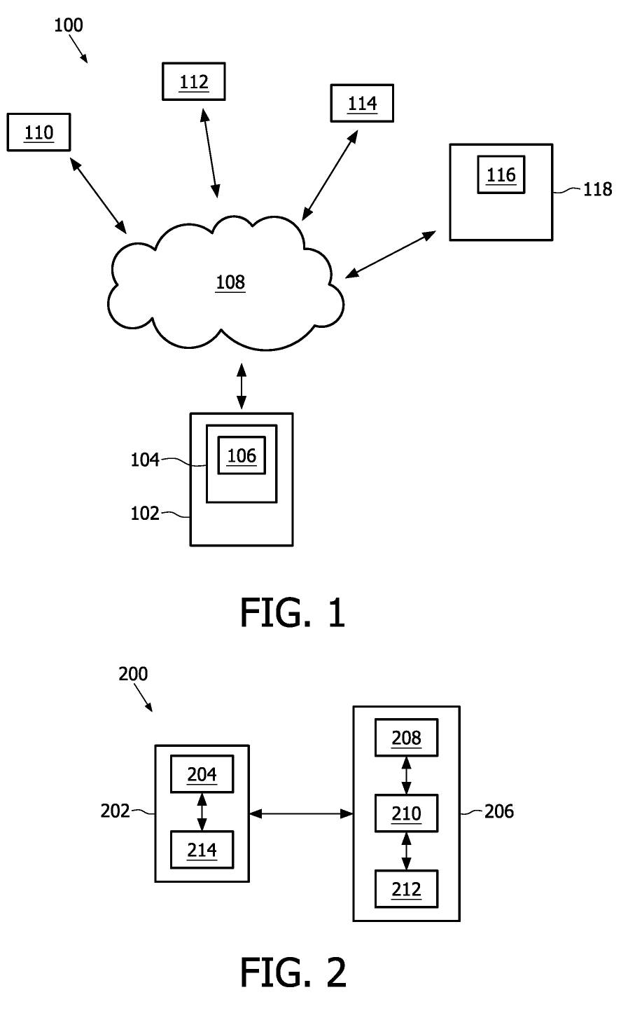

FIG. 1 illustrates client-server architecture according to the invention in a schematic way;

FIG. 2 illustrates a basic architecture of a client and a server according to the invention;

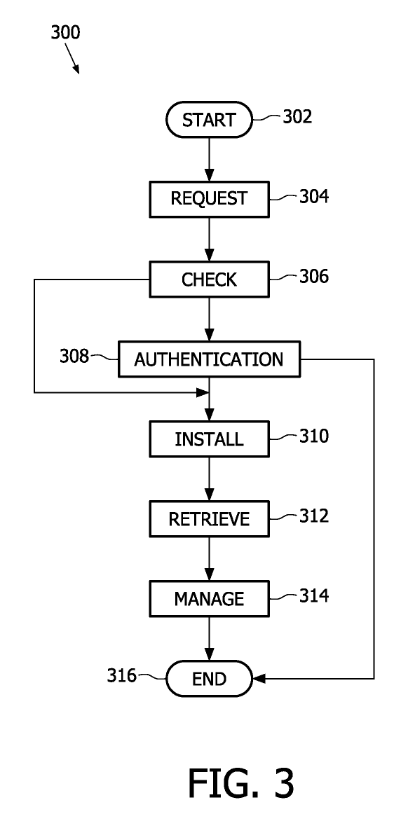

FIG. 3 illustrates a flowchart of the method according to the invention;

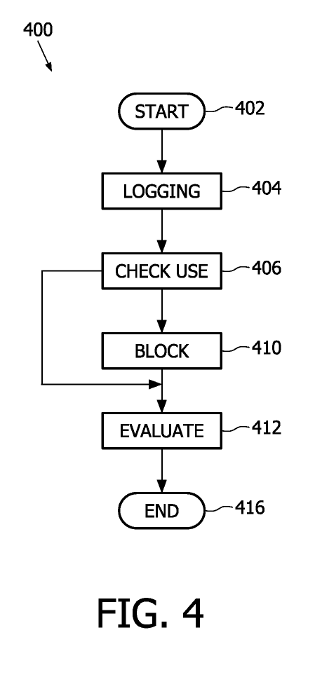

FIG. 4 illustrates a flowchart of a digital rights management service according to the invention.

FIG. 1 illustrates client-server architecture 100 according to the invention that comprises clients 110, 112, 114, and 116 that are connected to a server 106 through the Internet 108. The server is part of a medical information management system 104 that manages patient information in a hospital 102. Client 110 is part of a mobile heart monitor, client 112 is part of a mobile phone, client 114 is part of a medical workstation used for reviewing patient information by a home physician located at the home physician's practice, and client 116 is part of a medical workstation located in another hospital 118. Other devices such as for example a personal digital assistant may also embody the clients without departing from the concept of the invention. The medical information management system 104 may be designed to manage image data such as a PACS system, or to manage administrative patient data such as a HIS system, or to manage the scheduling of the patients on the different image acquisition devices such as a RIS system. The image acquisition devices are for example a Magnetic Resonance device (MR), an Ultrasound (US) device, X-Ray devices, etc. The clients are designed to establish a connection to the server through the Internet and the server is designed to respond to requests for establishing connections by clients. The interaction between the client and server is further described with reference to FIG. 3.

FIG. 2 illustrates a basic architecture 200 of a client 206 and a server 202 according to the invention. Both client, server and their respective components as described below, are implemented as computer readable code that can be executed by a processor of for example a general-purpose computer, such as a personal computer or the devices as mentioned with reference to FIG. 1. The server 202 holds the access policy 204 to the data that is managed by the medical information management system. The access policy may comprise access rights to the data, i.e. who is allowed to view what data and who is allowed to modify the data. Next to the data-centric access policy further access policies govern the use of data on uncertified clients and downloadable DRM services as a first aspect. Together with the original data-centric policies these are used to create an overall resulting access policy or license targeted for the request from the client. For example, the further access policy may comprise the duration that the data may be used or stored. As a second aspect there may be further access policies that define which and how much data is delivered in response to a request. These policies are therefore used to determine what data to deliver, but typically do not result in specific licenses delivered to the requesting clients as done with policies belonging to the first aspect. For both aspects it holds that context may be taken into account. For example, the policies may also relate to the identity or addresses of devices from which connections originate, the authenticated user, previous requests, etc. Further the server holds a connection establisher 214 that grants and establishes connections to clients and enables installing the downloadable DRM services when required such as when a connection to an uncertified client is established.

The client 206 comprises an Application Programming Interface (API) 208 that enables the client to establish a connection to a server, for example by implementing the Transmission Control Protocol (TCP) and sending requests according to the Hypertext Transfer Protocol (HTTP). Furthermore, the client offers an execution environment 210 for the DRM client. Examples for this include a virtual machine such as a Java virtual machine or Self-Protecting Digital Content (SPDC), see P Kocher, J Jaffe, B Jun, C Laren, N Lawson, Self-Protecting Digital Content, Cryptography Research Inc. White Paper, April, 2003, which offer the advantage that they are more or less platform independent. The client furthermore, comprises a component 212 that handles the download of DRM services, and enables execution thereof in the execution environment. The DRM service furthermore comprises an API that the client uses to request access to certain data, which typically involves license evaluation, data decryption, etc., by the DRM service. This component starts with downloading the DRM service, which it may do as part of the protocol itself by sending a request and getting the DRM service binary code as response, or it may do this outside the protocol by sending a download request using a standard web protocol such as HTTP to a location indicated by the server. The component stores the DRM service binary code in a writable memory, for example a harddisk, flash or Random Access Memory (RAM). Subsequently, it registers the DRM service binary code with the virtual machine, which results therein that the below-mentioned DRM service API is made available to programs running on the client and that need to use the DRM service. Finally the component calls the initialization method of the DRM client. The client exposes an API to the DRM service through the execution environment that the DRM service uses to communicate with the end-user, e.g. to display the data or to ask for input including authentication details, and other platform services such as network communication, storage, and for example a real-time clock.

FIG. 3 illustrates a flowchart of the method 300 according to the invention. Consider for example that the client is part of a mobile heart monitor that is used by a home physician while visiting a patient at the patient's home. The home physician wants to retrieve historical data of the patient from the server located at the hospital for comparison purposes with the information about the patient's heart. For this purpose the home physician requests the mobile heart monitor to retrieve the relevant information. In response, a client installed on the mobile heart monitor establishes a connection to the server in step 302. In the next step 304 the client sends the request to the server over the Internet using a dedicated request-response application protocol over generic web (-services) protocols such as the Simple Object Access Protocol (SOAP) over HTTP over TCP/IP. The server receives the request and checks within step 306 if the client implements the DRM as required by the server. It may perform this check using a secure challenge-response authentication using a public key and certificate comprised in the DRM service. If the client does not implement the DRM, the corresponding DRM is send to the client by the server. Optionally, within step 308 before installation or as part of or before steps 312 or 314, the client is asked for some user authentication. For example by asking the home physician to give his unique identification code, which especially works well if the physician has registered before with the system and at that moment registered his unique identification code, otherwise an other authentication or registration process is launched. Subsequently, this identification code is evaluated. Optionally, a first evaluation is performed to determine if the home physician is allowed to access the requested data based on the access policy and further access policies, which in case of positive evaluation results in continuation with the next step. The method continues towards installing the DRM within step 310. If the authentication is negative, the method ends in step 316, the DRM is not installed and the connection is terminated. Within step 310 the DRM is installed. When the DRM is installed the client is certified to interact with the server according to the DRM required by the server. Then, within step 312, the server sends the requested information encrypted with a content key to the client where it is under protection of the installed DRM. Typically, the data is accompanied with a license containing a rights expression derived from the policies and content key, which is encrypted such that only the DRM service on the client can decrypt it. After this, the retrieval is done. The server may perform logging depending on active policies as part of steps 306 to 312, e.g. record the request itself and related information such as request time, the delivered information together with the granted rights expression, the provided authentication information, etc. Optionally, the DRM installed in step 310 comprises embedded policies in executable code or data, which may be regarded as a specialized form of further access policies that are fixed for the client side. These policies are typically not data centric (as the policies of step 312 are) but hold in general for any data to be released using this DRM. These policies could be used by the client in step 312 where it is checked by the DRM service whether the user is allowed to retrieve the requested amount of data, e.g. uncertified clients may only retrieve a limited amount of data. These policy limitations may apply to the information of one patient, but it may also apply across patients, i.e. of how many patients information is allowed to be requested at the same time. This type of enforcement also works when the client interacts with multiple independent servers. Within step 314 the information is managed according to the DRM as explained in more detail with reference to FIG. 4. Now the home physician has access to the historical patient information and the method terminates in step 316.

FIG. 4 illustrates a flowchart of a digital rights management service 400 according to the invention. The DRM service starts with step 402 in which it initializes after which it continues to step 404. The initialization may comprise a self-integrity check, a check of the execution environment, retrieval of settings and context from the execution environment by making use of the API. Within step 404 it checks whether logging is enabled in the policies. If logging is enabled, the DRM service starts to log events. Events that are logged are the time and date the DRM service handles a request from the client. Other events may be logged as well, such as the name of the user of the client, the Internet Protocol address (IP address) of the client device, etc. The logged events may be directly or in batch-form be reported to the server using event reporting technology, which typically involves web-services technology. An example of event reporting technology is “MPEG-21 Event Reporting” as defined by the Moving Pictures Expert Group which is a working group of ISO/IEC. Within step 406, the DRM service checks how long the client uses the patient data. If the client uses the patient data longer than acceptable by the DRM, the patient data is blocked within step 410. The patient data may be blocked by preventing access to it, but also by deleting it from the client. For example if the patient data is used for longer than 2 hours, the patient data may be blocked. Other time periods may apply as well and the time periods may also depend upon the kind of patient data. For example, patient administrative data may be used for one day, while patient image data may be used for 5 days. Within step 412 the DRM service evaluates the rights expression contained in the retrieved license (accompanying retrieval of the data) that defines the resulting access policies. This thereby realizes usage control on the data. As part of this the DRM service verifies for example that the indicated user in the license matches the authenticated user from a previous step, that the usage period is still valid, that the data may be printed or not, etc. After successful evaluation the client uses the content key contained in the license to decrypt the encrypted data. After this, the data is ready for use by the trusted renderer. The trusted renderer is provided with information on what it may do with the data, and when necessary the trusted renderer contacts the DRM service again, e.g. when the user requests to print the data that is shown on the screen. After performing one or more of the previously described steps the DRM service terminates in step 416.

The client, the server and the DRM may be implemented as computer readable code to be loaded by a computer arrangement comprising a processing unit and a memory, that, after being loaded, provide the processing unit with the capability to perform the method according to the invention.

The order in the described embodiments of the method of the current invention is not mandatory, a person skilled in the art may change the order of steps or perform steps concurrently using threading models, multi-processor systems or multiple processes without departing from the concept as intended by the current invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A method of retrieving medical data from a server (106, 202) comprising:
requesting the medical data from the server by an uncertified client (110, 112, 114, 116, 206);
installing a certified digital rights management service on the uncertified client;
managing the requested medical data according to the installed certified digital rights management service thereby retrieving the medical data from the server.

2. A method according to claim 1, wherein access to the medical data is restricted according to an access policy and the uncertified client is restricted to access the medical data according to a further access policy and the certified digital rights management service obtains a resulting policy based upon the access policy and the further access policy.

3. A method according to claim 1, further comprising limiting a usability period of the medical data by the uncertified client.

4. A method according to claim 1, further comprising limiting the retrieved amount of the requested medical data.

5. A method according to claim 1, further comprising logging the medical data request.

6. A method according to claim 1, further comprising authentication of a user of the uncertified client before installing the certified digital rights management service or before retrieving the medical data from the server.

7. A system (200) for retrieving medical data from a server (106, 202) comprising:
means (208) for requesting the medical data from the server by an uncertified client (110, 112, 114, 116, 206);
means (214) for installing a certified digital rights management service on the uncertified client;
means (210) for managing the requested medical data according to the installed certified digital rights management service thereby retrieving the medical data from the server.

8. A server (106, 202) for use in the system according to claim 7, comprising means (214) for installing a certified digital rights management service on an uncertified client (110, 112, 114, 116, 206).

9. An uncertified client (110, 112, 114, 116, 206) for use in the system according to claim 7, comprising means (208) for requesting the medical data from the server (106, 202) by the uncertified client.

10. A medical workstation (118) comprising the uncertified client (110, 112, 114, 116, 206) according to claim 9.

11. A medical information management system (104) comprising the server (106, 202) according to claim 8.

12. A digital rights management service for use in a method or system according to claim 1, the digital rights management service designed to be loaded by a computer arrangement comprising a processing unit and a memory, the digital rights management service, after being loaded, providing the processing unit with the capability to manage requests and responses from an uncertified client (110, 112, 114, 116, 206) into request and responses for a server (106, 202) in order to enforce an access policy for medical data.
